(19) United States
(12) Patent Application Publication
(10) Pub. No.: US 2025/0235050 A1
(43) Pub. Date: Jul. 24, 2025

(54) COOKING POT LID LIFTING DEVICE

(71) Applicant: Robert Herrington, Guilford, CT (US)

(72) Inventor: Robert Herrington, Guilford, CT (US)

(21) Appl. No.: 19/006,978

(22) Filed: Dec. 31, 2024

Related U.S. Application Data
(60) Provisional application No. 63/622,153, filed on Jan. 18, 2024.

(51) Int. Cl. A47J 45/10

(52) U.S. Cl. CPC A47J 45/10

(57) ABSTRACT

A lid lifting device is disclosed which device may include a cylindrical body having a central axis, a first end, and a second end. In addition, the device may include a first finger guard projecting from a bottom side of the first end. The device may include a second finger guard projecting from a bottom side of the second end. Moreover, the device may include where the cylindrical body is fabricated from a thermally insulative material. Also, the device may include where the apparatus is configured to be removably positioned between a top surface of a pot lid and a bottom portion of a handle of the pot lid.

### CROSS REFERENCE TO RELATED APPLICATIONS

This application claims the benefit of U.S. Provisional Patent Application Ser. No. 63/622,153 filed 18 Jan. 2024. The disclosures of the application above is incorporated herein by reference in its entirety.

### BACKGROUND OF THE DISCLOSURE

### Field of the Disclosure

The present invention relates to an apparatus for safely handling lids for cooking pots. More specifically, the invention pertains to a lid lifter 10 made from thermally resistant material, such as silicone rubber, designed to protect users from burns while lifting cooking pot lids while they are hot.

### Description of the Prior Art

Cooking pots and their associated lids have been essential kitchen utensils for centuries. While the design and materials used in their construction have evolved, the basic function remains the same. One common issue faced by users when cooking with pots and lids is the potential for burns due to the transfer of heat from the pot and lid to the user's hand when removing the lid during cooking.

Various solutions have been proposed to address this issue, such as using oven mitts, towels, or pot holders. However, these solutions can be cumbersome, and they may not provide adequate protection against burns. Moreover, they often fail to provide a secure grip on the lid, which can lead to accidents and spills.

Therefore, there exists a need for an improved apparatus that allows for the safe and convenient handling of pot lids while cooking.

### SUMMARY

In one general aspect, an apparatus may include a cylindrical body having a central axis, a first end, and a second end. The apparatus may also include a first finger guard projecting from a bottom side of the first end. The apparatus may furthermore include a second finger guard projecting from a bottom side of the second end. The apparatus may in addition include where the cylindrical body is fabricated from a compliant material. The apparatus may moreover include where the apparatus is configured to be removably positioned between a top surface of a pot lid and a bottom portion of a handle of the pot lid.

Implementations may include one or more of the following features. The apparatus where an inside portion of the cylindrical body may include a plurality of longitudinal channels. The apparatus where the plurality of longitudinal channels form a grid pattern in the first end and the second end. The apparatus where the plurality of longitudinal channels may include any of a circular shape and a polygon shape. The apparatus where an outer dimension of the cylindrical body is selected to provide an interference fit between the top surface of the pot lid and the bottom portion of a handle of the pot lid. The apparatus where the compliant material may include a thermally resistant material. The apparatus may include a metal core embedded longitudinally within the cylindrical body. The apparatus where the first finger guard and the second finger guard are angled downward relative to the central axis. The apparatus where the cylindrical body includes a hydrophobic coating. The apparatus where the apparatus further includes surface textures on any of the cylindrical body, the first end and the second end. The apparatus where the first end and the second end may include a concave shape. The apparatus may include integrated magnets within the cylindrical body.

In one general aspect, a method may include providing an apparatus having a cylindrical body, a first end, a second end, a first finger guard, and a second finger guard. The method may also include positioning the apparatus releasably between a top surface of the cooking pot lid and a bottom portion of a handle of the cooking pot lid such that an interference fit is achieved. The method may furthermore include orienting the apparatus such that the first finger guard and the second finger guard contact the top surface of the pot lid. The method may in addition include gripping the first end and the second end of the apparatus. The method may moreover include lifting the pot lid using the apparatus.

Implementations may include one or more of the following features. The method where the cylindrical body may include a plurality of longitudinal channels. The method where the plurality of longitudinal channels form a grid pattern in the first end and the second end. The method where the plurality of longitudinal channels may include any of a circular shape and a polygon shape. The method where the cylindrical body may include a compliant material. The method where the compliant material may include a thermally resistant material. The method may include a metal core embedded longitudinally within the cylindrical body. The method where the cylindrical body includes a central axis and the first finger guard and the second finger guard are angled downward relative to the central axis. The method where the cylindrical body includes a hydrophobic coating. The method where the apparatus further includes surface textures on any of the cylindrical body, the first end and the second end. The method where the first end and the second end may include a concave shape.

### BRIEF DESCRIPTION OF THE DRAWINGS

So that the manner in which the above-recited features of the present disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a perspective view of a lid lifter in accordance with the current disclosure;

FIG. 2 is a top view of a lid lifter in accordance with the current disclosure;

FIG. 3 is a right side view of a lid lifter in accordance with the current disclosure;

FIG. 4 is an end view of a lid lifter in accordance with the current disclosure;

FIG. 5 is a side cross sectional view taken along cut line 5-5 of FIG. 4 of a lid lifter in accordance with the current disclosure;

FIG. 6 is a perspective view of a lid lifter installed for use in accordance with the current disclosure;

FIG. 7 is a perspective view of a lid lifter in accordance with the current disclosure; and

FIG. 8 is an end view of a lid lifter in accordance with the current disclosure.

### DETAILED DESCRIPTION

In the following detailed description, reference is made to the accompanying drawings, which form a part hereof, and within which are shown by way of illustration specific implementations by which the examples described herein may be practiced. It is to be understood that other implementations may be utilized and structural changes may be made without departing from the scope of the disclosure.

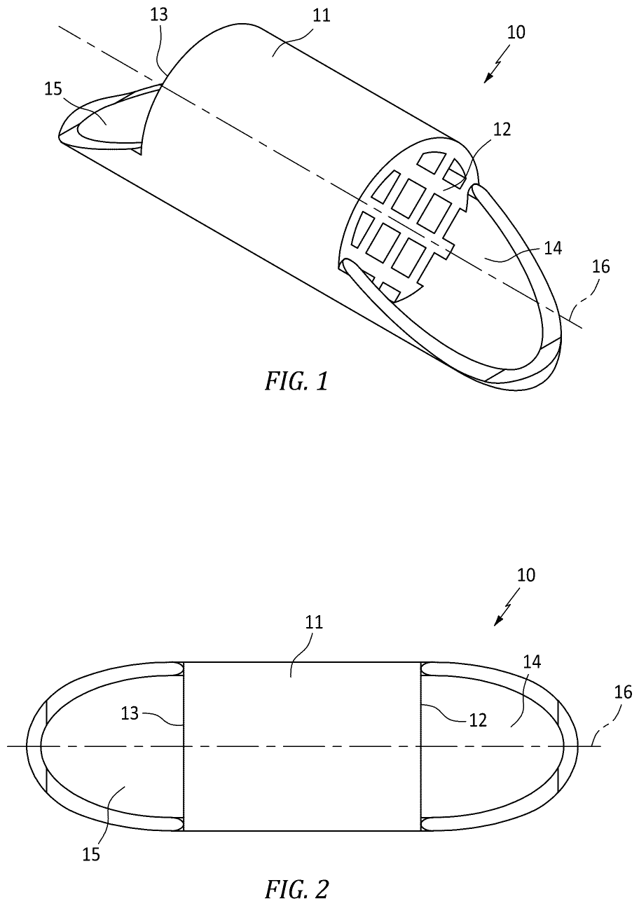

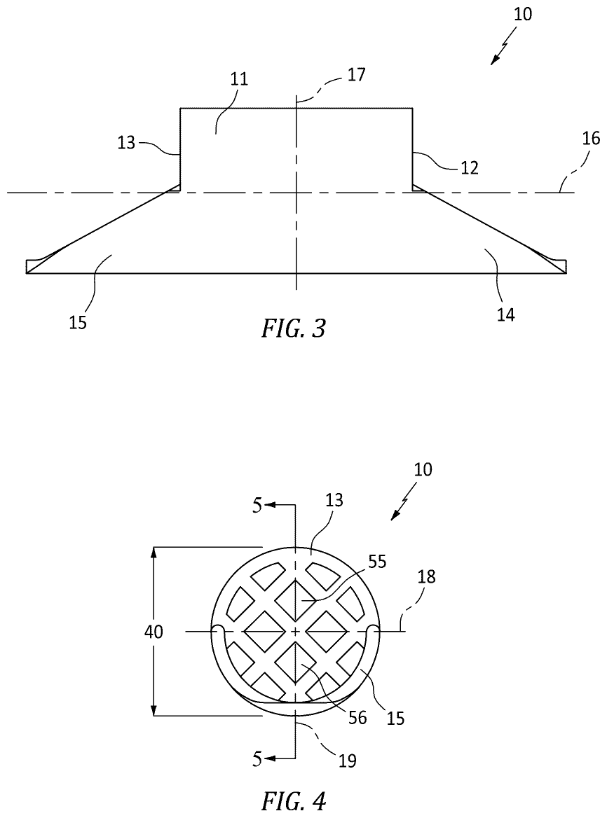

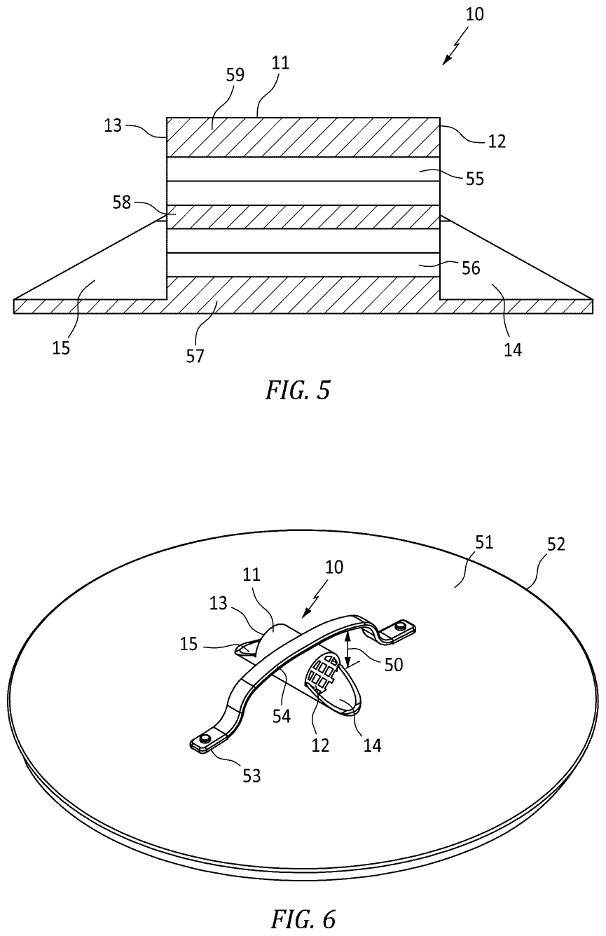

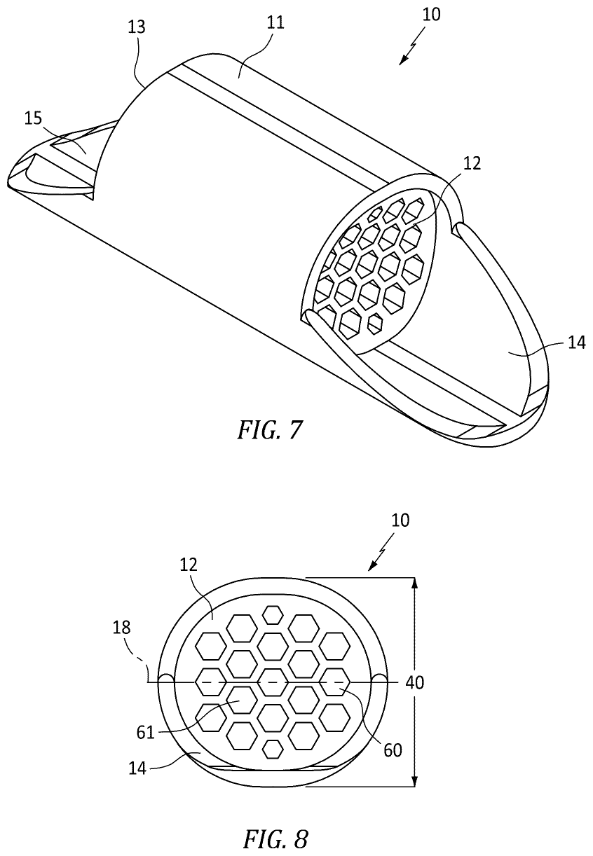

Referring to FIGS. 1-5, there is shown an embodiment of lid lifter 10 of the current disclosure. Lid lifter 10 is comprised of a body 11, a first end 12, a second end 13, first finger guard 14 projecting from a bottom side of the first end and a second finger guard 15 projecting from a bottom side of the second end. First finger guard 14 and a second finger guard further each a skirt portion that project downwardly from central axis 16. Body 11 is shown as comprising an elongated cylindrical shape centered about central axis 16 running longitudinally through cylindrical body 11, although other shapes are contemplated as being within the scope of the present disclosure. Lid lifter 10 is essentially symmetrically shaped about central axis 16 (FIG. 3). First end 12 and second end 13 are shown as generally planar in shape, concentric with body 11 and perpendicular to central axis 16 and the body. First end 12 and second end 13 are shown as comprising a grid pattern configured to allow the cylinder of body 11 to be exposed to the atmosphere to allow for gripping, cleaning and venting as will be disclosed in more detail hereinafter. As can best be seen with reference to FIG. 5, the grid pattern of first end 12 and second end 13 comprise a plurality of channels 55, 56, among the others shown, that extend longitudinally through body 11 and form ribs 57-59 among others shown. Although shown as having a square shape, the plurality of longitudinal channels can comprise other shapes such as circular shape and hexagonal or other polygon shape (as shown in FIGS. 7 & 8). Although shown as having a grid pattern, any opening (or no opening at all, i.e. body 11 can be solid) is contemplated as being within the scope of the present disclosure. In addition, first end 12 and second end 13 can comprise caps and body 11 can be hollow between the first end and the second end. First finger guard 14 and a second finger guard 15 are shown as projecting angularly downward and away relative to body 11 and central axis 16 and follow the contour of the body concentrically about centerlines 18, 19 (FIG. 4). It will be appreciated by those skilled in the art the various features disclosed directly hereinabove are inventively configured to provide an apparatus for safe handling of pot lids as set forth in the following detailed description.

The lid lifter 10 can be fabricated from a compliant thermally resistant material, such as silicone rubber, known for its excellent heat resistance properties. Silicone rubber, or other similar material, can be chosen due to its ability to withstand high temperatures, making it suitable for use in a cooking environment. The material is also non-toxic and easy to clean, ensuring food safety and hygiene. In addition, the use of silicone rubber or other similar material allows lid lifter 10 to be molded as an integral piece using injection molding, 3D printing, or other manufacturing techniques. Although described herein as compliant, any suitable material is contemplated by the current disclosure wherein such materials share characteristics such as flexibility, elasticity, and resilience to permanent deformation. Such materials contemplated by the current disclosure include, but are not limited to, compliant materials like silicone rubber, particularly focusing on materials with similar flexibility and properties: elastomers, thermoplastic elastomers (TPE), latex, foam rubber neoprene, polyurethane (PU), EPDM (Ethylene Propylene Diene Monomer), nitrile rubber (NBR), viton, sponge silicone, natural rubber, butyl rubber, flex polymers, soft PVC (Polyvinyl Chloride), and memory foam.

The lid lifter 10 features a cylindrical body 11 that serves as the central structure of the apparatus. This cylindrical body 11 is partially closed at first end 12 and second end 13 and provides the user with a comfortable and secure grip as will be disclosed in more detail hereinafter. The cylindrical body 11 is designed to have an outer dimension 40 that is slightly larger than the distance 50 between the top 51 of the cooking pot lid 52 and the bottom portion 53 of the lid handle 54 (FIG. 6) of a conventional cooking pot (not shown). This sizing allows for a secure, interference fit, with the compliant material of lid lifter 10 to apply a biasing force between the top 51 of the cooking pot lid 52 and the bottom portion 53 of the lid handle 54, ensuring that the lid lifter 10 remains firmly in place during use.

### Operation

With reference to FIG. 6, the operation of the lid lifter 10 can best be described for use with a lid 52 of a cooking pot having a D-shaped handle 54 that projects from the top 51 of the lid. Before using the lid 52 of a cooking pot while cooking, a user positions the body 11 of lid lifter 10 between the top surface 51 of the lid and the lower portion 53 of the lid handle 54. The user orients lid lifter 10 such that a bottom surface of body 11 and first finger guard 14 and second finger guard 15 are in contact with top surface 51 of cooking pot lid 52. Lid lifter 10 remains removably positioned between top surface 51 and bottom portion 53 of handle 54 by the deformation caused in body 11 by the interference fit therebetween. The user grips the lid lifter 10 by placing a thumb on a first end and a finger on a second end 13 and applying a gripping force. While maintaining the grip, the user lifts the cooking pot lid 52 using the lid lifter 10. The ribs formed between longitudinal channels 55, 56 (and other channels) provide body 11 with sufficient compression capability to avoid collapse due to the gripping force applied by a user. Again, the interference fit ensures that the lifter remains securely in place. During use, the user is effectively protected from the heat of the cooking pot lid 52 and handle 54 throughout the process, by virtue of the thermally resistant material from which the lid lifter 10 is constructed. Additionally, in embodiments featuring first finger guard 14 and second finger 15, further protection is provided by preventing contact of the user's fingers with the hot lid's surface 51.

It should be appreciated those skilled in the art that lid lifter 10 is advantageously configured to provide for the safe handling of pot lids and offers several advantages over existing prior art solutions. An advantage of the lid lifter 10 is its ability to protect users from burns while handling cooking pot lids while they are hot. The thermally resistant material and design ensure that the user's hand remains cool and safe, even when dealing with high cooking temperatures. The lid lifter 10 design allows for a secure and comfortable grip, reducing the risk of accidents and spills. The lid lifter 10 can be used with a wide range of cooking pots that have handles, making it a versatile kitchen accessory. In embodiments with openings in the first end 12 and the second end 13, cleaning the longitudinal channels 55, 56 and ribs 57-59 of inside portion of the cylindrical body 11 is effortless, ensuring the maintenance of hygiene.

In embodiments wherein lid lifter 10 is comprised of a durable material, such as a silicone rubber, which is known for its durability, makes the lid lifter 10 a long-lasting kitchen tool.

It should be appreciated by those skilled in the art that lid lifter 10 is an apparatus for safe handling of pot lids, as described herein, and represents an innovative and practical solution to the problem of burns caused by cooking pot lids during cooking. Made from a thermally resistant material, such as silicone rubber, and featuring a cylindrical body 11 with ends 12,13, the lid lifter 10 provides enhanced safety, a secure grip, and versatility in its application. Additional features, such as finger guards 14,15 and openings for ventilation and cleaning, further contribute to its usability and convenience. The lid lifter 10 is a useful addition to any kitchen, ensuring that users can cook safely and comfortably while protecting their hands from the heat of pot lids and handles.

Now referring to FIGS. 7 and 8, there is shown another embodiment of lid lifter 10 of the current disclosure. Lid lifter 10 is comprised of a body 11, a first end 12, a second end 13, first finger guard 14 projecting from a bottom side of the first end and a second finger guard 15 projecting from a bottom side of the second end. Body 11 is shown as comprising an elongated cylindrical shape centered about a center axis although other shapes are contemplated as being within the scope of the present disclosure. First end 12 and second end 13 are shown as a slightly concave shape and concentric with body 11. First end 12 and second end 13 are shown as comprising a honeycomb grid pattern comprised of hexagonal shaped longitudinal channels 60, 61, among the others shown, extending through body 11. The honeycomb grid pattern allows body 11 to be compliant and further allows the cylinder of body 11 to be exposed to the atmosphere to allow for cleaning and venting as will be disclosed in more detail hereinafter. Although shown as having a honeycomb grid pattern, any opening (or no opening at all, i.e. body 11 can be solid) is contemplated as being within the scope of the present disclosure. In addition, first end 12 and second end 13 can comprise caps and body 11 can be hollow between the first end and the second end. First finger guard 14 and a second finger guard 15 are shown as projecting angularly downward toward a bottom side of the body. It will be appreciated by those skilled in the art the various features disclosed directly hereinabove are inventively configured to provide an apparatus for safe handling of pot lids as set forth in the following detailed description.

In certain embodiments, the body 11 and ends 12, 13 of the lid lifter 10 may include additional surface textures or patterns beyond the grid or honeycomb structure. For example, a series of longitudinal ridges or dimples may be incorporated along the cylindrical surface 11 or ends 12, 13 to improve grip, even when the user's hands are wet or oily. These surface features may also provide an aesthetic enhancement to the lid lifter, making it a visually appealing kitchen tool.

Additionally, the finger guards 14, 15 can be designed with varying thicknesses or curvature profiles to enhance user comfort and heat shielding. For instance, finger guards 14, 15 with a concave inner surface provide a natural resting place for the user's fingers (including thumbs), reducing strain during prolonged use. In some implementations, the guards may also feature small vents or perforations to dissipate heat more effectively.

While silicone rubber is a suitable material due to its heat resistance, other materials can be used depending on the specific needs of the user. Examples include thermoplastic elastomers (TPEs), which offer similar flexibility and heat resistance, or hybrid materials that combine silicone with reinforcing fibers for added durability.

In embodiments where the lid lifter is designed for heavy-duty use, such as in commercial kitchens, a metal (or other suitable rigid material) core may be embedded within the cylindrical body. This core can provide additional structural support while maintaining the outer thermally resistant layer. For instance, a stainless-steel metal core may be used, ensuring resistance to corrosion and mechanical fatigue.

The choice of material also extends to surface coatings. For example, a hydrophobic coating can be applied to the surface of the lid lifter to repel water, grease, and other contaminants. Such a coating not only enhances the ease of cleaning but also improves hygiene, an important consideration for food-related applications.

The manufacturing process for the lid lifter can utilize state-of-the-art techniques to achieve precision and efficiency. For example, injection molding is ideal for producing high volumes of the product with consistent quality. During the molding process, features such as the grid pattern, finger guards, and end openings can be formed in a single step, minimizing production costs.

Alternatively, 3D printing technology can be employed for prototyping or custom designs. This technique allows for rapid iteration of new features or variations, such as custom-fit lid lifters for non-standard pot lid configurations. Materials like flexible filaments can be used in 3D printing to mimic the properties of silicone rubber.

Multi-material manufacturing can be used as an alternate method, where different materials can be combined during the molding process. For instance, a rigid inner core can be overmolded with a soft, heat-resistant outer layer, providing a balance between strength and flexibility.

Additional embodiments of the lid lifter are contemplated by the current disclosure for specific user needs. In one alternative embodiment, the cylindrical body can be divided into two hinged halves, allowing the lid lifter to be opened and closed around the handle of the pot lid. This design is particularly useful for lids with non-removable handles, as it allows for easy installation and removal.

A further embodiment can include integrated magnets within the body 11. The magnets allow the lid lifter to be conveniently attached to the side of a metal pot or kitchen appliance when not in use, preventing misplacement.

The lid lifter is designed to be versatile and suitable for a wide range of cooking scenarios. For example, it can be used not only with conventional pot lids but also with specialty cookware such as tagines, pressure cookers, or steamers. Its adjustable interference fit and flexible material accommodate handles of various shapes and sizes.

The lid lifter 10 is also suitable for use in outdoor cooking environments, such as camping or barbecues. In such settings, the thermally resistant material ensures safety when handling lids exposed to open flames or high heat. Furthermore, the lightweight design makes it easy to transport, and its robust construction withstands the rigors of outdoor use.

To further enhance user safety, embodimets are contemplated by the current disclosure wherein the lid lifter 10 may include visual indicators, such as colored stripes or patterns, that change color when exposed to excessive heat. These indicators provide a clear visual cue to the user, warning them if the lid lifter 10 is too hot to handle.

In embodiments designed for children or individuals with limited dexterity, the finger guards 14, 15 can be enlarged or padded with additional material to provide a more secure and comfortable grip.

The lid lifter 10 of the current disclosure represents a significant advancement in the field of kitchen tools, offering a combination of safety, functionality, and user convenience. Its thoughtful design and innovative features make it an essential accessory for any cooking environment, ensuring that users can handle hot cooking pot lids 52 with safety, confidence and ease.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for handling a cooking pot lid, comprising:
a cylindrical body having a central axis, a first end, and a second end;
a first finger guard projecting from a bottom side of the first end, a second finger guard projecting from a bottom side of the second end;
wherein the cylindrical body is fabricated from a compliant material; and
wherein the apparatus is configured to be removably positioned between a top surface of a pot lid and a bottom portion of a handle of the pot lid.

2. The apparatus of claim 1, wherein an inside portion of the cylindrical body comprises a plurality of longitudinal channels.

3. The apparatus of claim 1, wherein an outer dimension of the cylindrical body is selected to provide an interference fit between the top surface of the pot lid and the bottom portion of a handle of the pot lid.

4. The apparatus of claim 1, wherein the compliant material comprises a thermally resistant material.

5. The apparatus of claim 2, wherein the plurality of longitudinal channels form a grid pattern in the first end and the second end.

6. The apparatus of claim 5, wherein the plurality of longitudinal channels comprise any of a circular shape and a polygon shape.

7. The apparatus of claim 1, further comprising a metal core embedded longitudinally within the cylindrical body.

8. The apparatus of claim 1, wherein the first finger guard and the second finger guard are angled downward relative to the central axis.

9. The apparatus of claim 1, wherein the cylindrical body includes a hydrophobic coating.

10. The apparatus of claim 1, wherein the apparatus further includes surface textures on any of the cylindrical body, the first end and the second end.

11. The apparatus of claim 1, wherein the first end and the second end comprise a concave shape.

12. The apparatus of claim 1, further comprising integrated magnets within the cylindrical body.

13. A method of handling a cooking pot lid, the method comprising:
providing an apparatus comprising a cylindrical body, a first end, a second end, a first finger guard, and a second finger guard;
positioning the apparatus releasably between a top surface of the cooking pot lid and a bottom portion of a handle of the cooking pot lid such that an interference fit is achieved;
orienting the apparatus such that the first finger guard and the second finger guard contact the top surface of the pot lid; and
gripping the first end and the second end of the apparatus, and lifting the pot lid using the apparatus.

14. The method of claim 13, wherein the cylindrical body comprises a plurality of longitudinal channels.

15. The method of claim 13, wherein the cylindrical body comprises a compliant material.

16. The method of claim 15, wherein the compliant material comprises a thermally resistant material.

17. The method of claim 14, wherein the plurality of longitudinal channels form a grid pattern in the first end and the second end.

18. The method of claim 17 wherein the plurality of longitudinal channels comprise any of a circular shape and a polygon shape.

19. The method of claim 13, further comprising a metal core embedded longitudinally within the cylindrical body.

20. The method of claim 13, wherein the cylindrical body includes a central axis and the first finger guard and the second finger guard are angled downward relative to the central axis.

21. The method of claim 13, wherein the cylindrical body includes a hydrophobic coating.

22. The method of claim 13, wherein the apparatus further includes surface textures on any of the cylindrical body, the first end and the second end.

23. The method of claim 13, wherein the first end and the second end comprise a concave shape.

24. The method of claim 13, further comprising integrated magnets within the cylindrical body.
